(19) United States
(12) Patent Application Publication
(10) Pub. No.: US 2024/0019609 A1
(43) Pub. Date: Jan. 18, 2024

(54) FORMING AN OPTICAL SYSTEM

(71) Applicant: AMS-OSRAM ASIA PACIFIC PTE. LTD., Singapore (SG)

(72) Inventors: Ilias BOSDAS, Zuerich (CH); Martin GAMBLE-SALT, Samstagern (CH); Nicola SPRING, Oberterzen (CH)

(21) Appl. No.: 18/256,641

(22) PCT Filed: Nov. 26, 2021
(86) PCT No.: PCT/SG2021/050730

§ 371 Date: Jun. 9, 2023

(30) Foreign Application Priority Data
Dec. 11, 2020 (GB) 2019552.5

(51) Int. Cl. G02B 3/00; G02B 7/00; B29D 11/00

(52) U.S. Cl. CPC G02B 3/0012; G02B 7/003; G02B 3/0075; B29D 11/00009

(57) ABSTRACT

A method of forming an optical system is disclosed. The optical system may include a lens and another optical element. The method may include forming a master tool using a lithographic apparatus, using the master tool to form a substrate comprising a plurality of lenses and associated lens alignment features, dicing the substrate to form individual substrates each having a lens with an integrated lens alignment feature, locating the other optical element in a jig, and placing a lens of the plurality of lenses in the jig such that the integrated alignment feature for said lens rests against surfaces of the jig thereby placing the lens is in a desired position relative to the other optical element.

### CROSS-REFERENCE TO RELATED APPLICATIONS

The present application is a national stage entry according to 35 U.S.C. §371 of PCT application No.: PCT/SG2021/050730 filed on Nov. 26, 2021; which claims priority to British patent application 2019552.5, filed on Dec. 11, 2020; all of which are incorporated herein by reference in their entirety and for all purposes.

### TECHNICAL FIELD

The present invention relates to forming an optical system comprising a lens and another optical element.

### BACKGROUND

Various types of optical systems are incorporated into a wide range of consumer and industrial products and systems. One such optical system comprises an optical element in the form of a prism and a lens. The lens is typically attached to the optical element using an adhesive and a pick-and-place machine is used to position the lens onto a surface of the optical element. The optical system can then be integrated, for example, into a mobile phone.

### SUMMARY

The inventors of the present disclosure have identified that for certain applications very precise positioning between an optical element and a lens is required. The optical element may be a prism, a beam splitter, an assembly of optics, a diffraction grating, a fibre optic, an element with one or more apertures etc. The conventional technique of using a pick-and-place machine cannot provide the level of accuracy required

One such application is in a consumer device such as a mobile phone. The mobile phone comprises an aperture for receiving light. The light is incident on a lens adhered to an optical element, in the form of a prism, which directs the incident light towards an image sensor that is operable to capture an image of the environment of the mobile phone. The importance for a precise lens positioning is on the optical aberrations and therefore the final image quality. In particular, a poor alignment between the lens and the optical component would introduce astigmatism in the first order and coma in the second order.

According to one aspect of the present disclosure there is provided a method of forming an optical system comprising a lens and another optical element, wherein the method comprises: forming a master tool using a lithographic apparatus; using the master tool to form a substrate comprising a plurality of lenses and associated lens alignment features; dicing the substrate to form individual substrates each having a lens with an integrated lens alignment feature; locating the other optical element in a jig; and placing a lens of the plurality of lenses in the jig such that the integrated alignment feature for said lens rests against surfaces of the jig thereby placing the lens is in a desired position relative to the other optical element.

Embodiments of the present disclosure provide accurate placement of the lens relative to the optical element, and this is achieved in a manner which is efficient for mass production (high volumes and high UPH, units per hour).

Because the lenses and alignment features are formed using the same lithographic apparatus they are precisely aligned relative to each other. In particular, the lens and the alignment feature are formed using the same master tool guaranteeing the best possible manufacturing tolerance.

In embodiments of the present disclosure the alignment of the lens relative to the optical element is performed mechanically (for example using gravity) and thus the alignment accuracy is not limited by machine capabilities (such as the positioning accuracy of a pick-and-place machine).

The lens may be placed in the jig such that a first surface of the integrated alignment feature extending in a first direction rests against a first surface of the jig, and a second surface of the integrated alignment feature extending in a second direction orthogonal to the first direction rests against a second surface of the jig.

In some implementations, in the desired position the first surface of the integrated alignment feature is in the same plane as a first surface of the optical element, and the second surface of the integrated alignment feature is in the same plane as a second surface of the optical element.

In some implementations, the first surface of the integrated alignment feature and the second surface extend in a third direction that is parallel to an optical axis of the lens.

The jig may comprise a cavity and once said lens is placed in the jig, portions of the individual substrate onto which said lens has been formed onto, may extend into said cavity.

In some implementations, the other optical element is located in said jig such that during said placing gravity guides the lens into the desired position.

The master tool may be formed such that when the substrate is diced, the individual substrates each have a lens with a single integrated lens alignment feature.

The master tool may be formed such that when the substrate is diced, the individual substrates each have a lens with a plurality of integrated lens alignment features.

In some implementations, the master tool is formed such that when the substrate is diced, the individual substrates each have a lens with an integrated lens alignment feature provided at each corner of the individual substrate. This advantageously provides flexibility in the orientation in which the lens can be placed into the jig.

Forming the master tool using the lithographic apparatus may comprise: depositing replication material onto a master tool forming substrate; hardening the replication material to form hardened replication material shaped corresponding to said lenses; dispensing liquid photoresist onto the master tool forming substrate; exposing light to only selected portions of the liquid photoresist to form hardened photoresist shaped corresponding to the lens alignment features; removing remaining unexposed liquid photoresist; depositing a liquid material over the substrate, the hardened replication material, and the hardened photoresist; curing said liquid material to form the master tool.

The exposing light to only selected portions of the liquid photoresist may comprise: positioning a transparent masking structure over the master tool forming substrate, the masking structure comprising a masking layer; and emitting the light through said masking structure.

Using the master tool to form the substrate comprising a plurality of lenses and associated lens alignment features may comprise: aligning the master tool and the substrate with respect to each other and bringing the master tool and a first side of the substrate together, with replication material between the master tool and the substrate; hardening the replication material; and separating the tool from the substrate with the hardened replication material adhering to the substrate and forming the plurality of lenses and associated lens alignment features.

The other optical element may be a prism, for example a right-angled prism.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

Some embodiments of the disclosure will now be described by way of example only and with reference to the accompanying drawings, in which:

FIG. 1 illustrate a process for manufacturing an optical system;

FIG. 2 illustrates a process for manufacturing a master tool;

FIG. 3a illustrates a side view of a lens formed on a substrate having multiple alignment features;

FIG. 3b illustrates a perspective view of a lens formed on a substrate having multiple alignment features;

FIGS. 3c and 3d illustrate example alignment features;

FIGS. 3e and 3f illustrate how a lens may be orientated when placed in a jig;

FIGS. 4a and 4b illustrates the positioning of a lens onto an optical element that is placed in a jig;

FIGS. 5a-5c illustrates perspective views of a lens positioned onto an optical element that is placed in a jig;

FIG. 6 illustrates an optical system manufactured according to embodiments of the present disclosure; and

FIG. 7 illustrates an example computing device incorporating an optical system.

### DETAILED DESCRIPTION

Generally speaking, the present disclosure relates to forming an optical system comprising a lens and another optical element. A lithographic apparatus is used to form a master tool which includes replication surfaces for forming lenses and associated alignment features. The master tool is then used to form lenses and their integrated alignment features, e.g. in a sheet of hundreds or thousands of lenses. Because the lenses and their integrated alignment features are formed using the master tool they are precisely aligned relative to each other. The sheet is then diced. Each lens is fitted to an optical element using a jig which has precisely positioned surfaces that receives an alignment feature of the lens. Embodiments of the present disclosure thus provide precise positioning of the lens relative to the optical element.

Some examples of the solution are given in the accompanying figures.

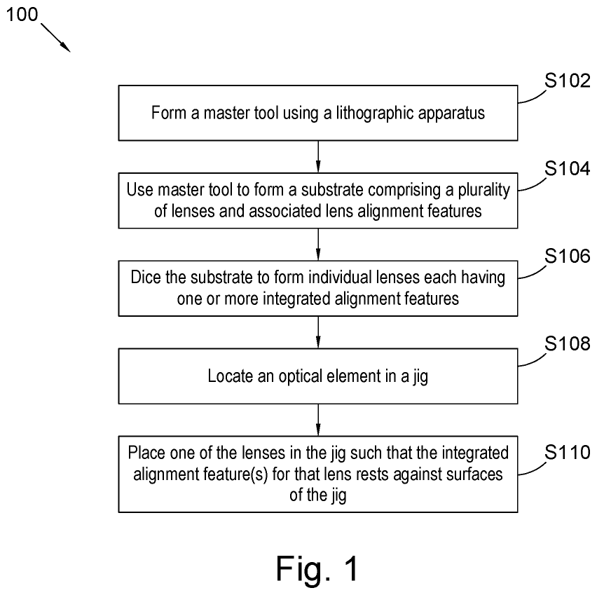

FIG. 1 illustrate a process 100 for manufacturing an optical system according to embodiments of the present disclosure.

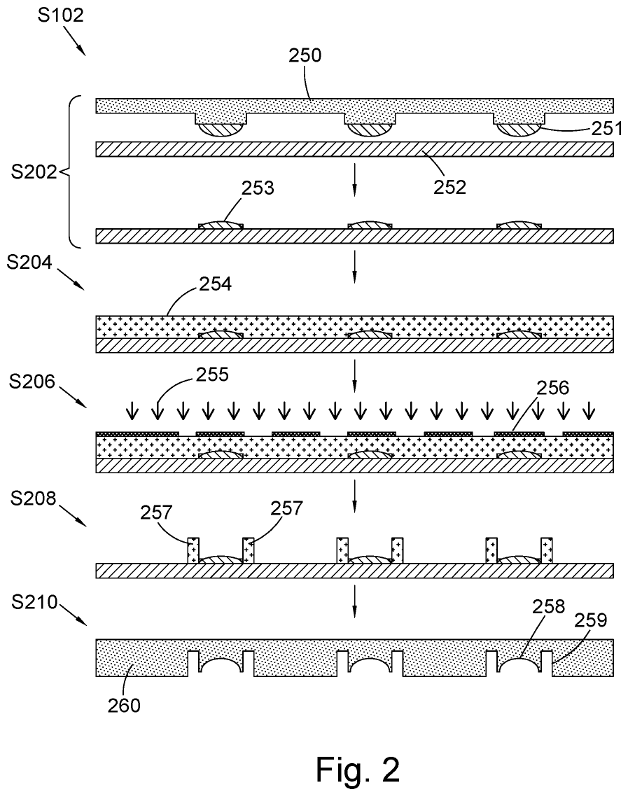

At step S102, a lithographic apparatus is used to form a master tool. Step S102 is illustrated in more detail in FIG. 2.

As shown in FIG. 2, at step S202 a dispensing tool 250 with a replication material 251 (e.g. epoxy resin) on its replication surfaces and a master tool forming substrate 252 are brought together. The substrate 252 may be a “wafer”, or other base element. Thus, the process 100 can be considered a wafer level optics processing method. The substrate 252 may for example be made of glass. By bringing the dispensing tool 250 and the substrate 252 together (e.g. by lowering the dispensing tool 250 towards the substrate 252), the replication material 251 is deposited onto an upper surface of the substrate 252. The replication material 251 is then cured by exposing it to light e.g. ultraviolet light. The curing process hardens the replication material to result in hardened replication material on the upper surface of the substrate 252. The hardened replication material 253 is shaped corresponding to lenses that are to be used in the optical system.

At step S204, liquid photoresist 254 is dispensed onto the master tool forming substrate 252. The liquid photoresist 254 may for example be a UV-curable hybrid polymer, examples materials for the liquid photoresist 254 are known to persons skilled in the art.

At step S206 a light source is used to emit light 255 towards the master tool forming substrate 252 and expose only selected portions of the liquid photoresist 254 to form hardened photoresist 257 which is shaped corresponding to lens alignment features that are to be used in the optical system. The light 255 may be ultraviolet (UV) light.

Step S206 may be performed by positioning a transparent masking structure adjacent to the master tool forming substrate 252. The masking structure comprises a suitably transparent material (e.g. glass) through which light can pass on which is disposed a masking layer 256. The masking layer 256 may be made of metal (e.g. chromium), black ink or paint, or any other suitably opaque material. The light source is positioned such that emitted light 255 is then incident on the masking structure. The light 255 has wavelength(s) capable of curing the liquid photoresist 254, and which are capable of being transmitted by the masking structure and of being absorbed, reflected and/or otherwise blocked by the masking layer 256. Embodiments are not limited to the light 255 being UV light, and other light having other wavelengths may be used. For example, visible light curing is also possible. When visible light is used, the same materials (to be cured) can be used as with UV light but with different photoinitiators.

At step S208, the remaining unexposed liquid photoresist is removed. In particular, the remaining unexposed liquid photoresist is washed away.

At step S210 a liquid material is deposited over the master tool forming substrate 252, the hardened replication material 253, and the hardened photoresist 257, this liquid material is cured to form the master tool 260. The liquid material may be thermally cured or optically cured. One example material of the master tool 260 is silicon however it will be appreciated that other types of material may be used to form the master tool 260.

As shown in FIG. 2, the master tool 260 has a replication surface comprising a plurality of replication sections 258, the surface of each of which is a (negative) copy of a surface shape of a lens to be manufactured whereby the replication surface additionally has, for each lens, one or more replication section 259 the surface of each of which is a (negative) copy of a surface shape of an alignment feature to be manufactured. The replication section 258 for a lens and the replication section(s) 259 for the alignment feature(s) are in the same master tool 260 which ensures the best possible accuracy of the positioning of the lens and an optical element which will be described in more detail below.

We now refer back to the process 100 shown in FIG. 1.

At step S104 the master tool 260 is used to form a substrate comprising a plurality of lenses and associated lens alignment features. In particular, a replication material (e.g. epoxy resin) is deposited on the replication surfaces 258,259 of the master tool 260, and a substrate (which is different to the master tool forming substrate 252 referred to above) and the master tool 260 are then brought together. The substrate onto which the plurality of lenses and associated lens alignment features are formed comprises a suitably transparent material (e.g. glass) through which light can pass.

By bringing the master tool 260 and the substrate together (e.g. by lowering the master tool 260 towards the substrate), the replication material is deposited onto an upper surface of the substrate. The replication material is then cured by thermal curing or optical curing. The curing process hardens the replication material to result in hardened replication material on the upper surface of the substrate. The hardened replication material is shaped corresponding to lenses and their associated integrated alignment feature(s). As will be appreciated, a lens and its associated integrated alignment feature(s) are made of the same material.

The master tool 260 can be used to form a plurality of lenses and their associated integrated alignment feature(s) onto the substrate. That is, the substrate may have tens, hundreds or thousands of lenses and their associated integrated alignment feature(s).

At step S106 the substrate onto which the lenses and their associated integrated alignment feature(s) have been formed is diced. The dicing of the substrate results in a plurality of structures 300 each comprising an individual substrate 306 with a single lens 302 and the lens's integrated alignment feature(s) 304 formed thereon.

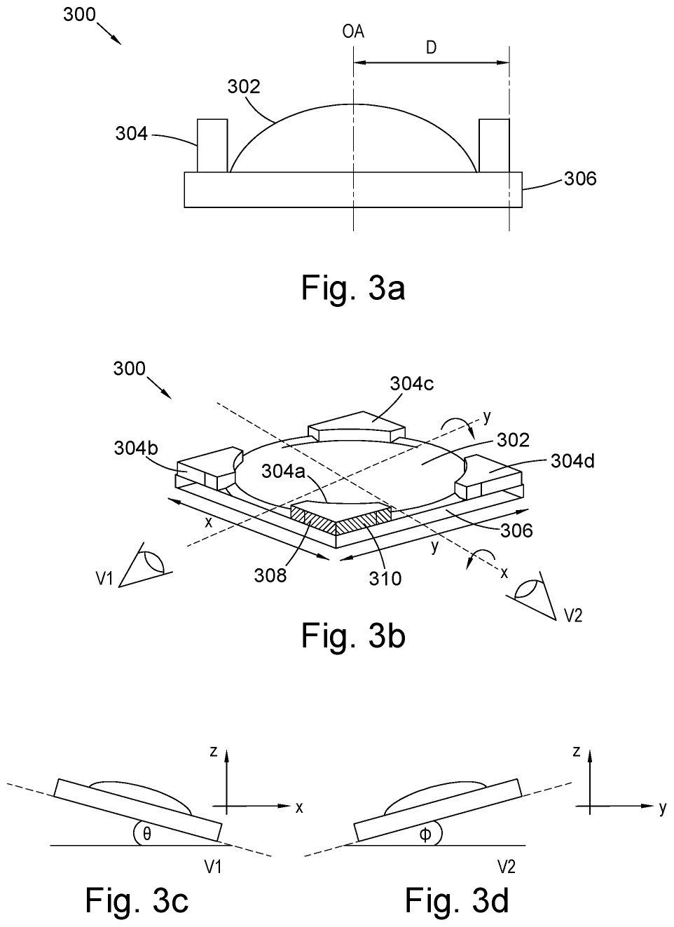

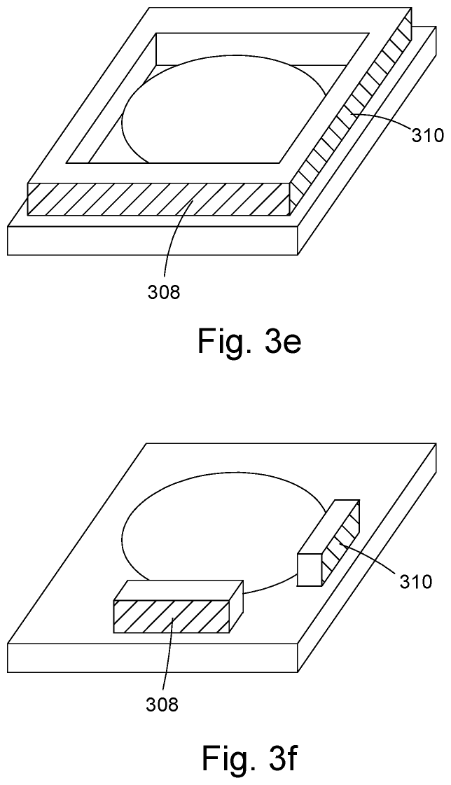

The lens 302 may have a single integrated alignment feature or alternatively have multiple integrated alignment features. FIG. 3a illustrates a side view of an example lens 302 formed on an individual substrate 306 (after dicing) having four alignment features 304 provided at each corner of the individual substrate. As shown in FIG. 3a, the lens 302 is associated with an optical axis which extends in the z-direction (also referred to herein as a third direction) through the centre of the lens 302. Each of the alignment features may have surfaces which extend in a direction that is parallel to the optical axis of the lens.

FIG. 3b illustrates a perspective view of an example lens formed on a substrate having multiple alignment features. As is illustrated with respect to the alignment feature 304a shown in FIG. 3b, each of the multiple alignment features has a first surface 308 extending in the x-direction (also referred to herein as a first direction) and a second surface 310 extending in the y-direction (also referred to herein as a second direction) which is orthogonal to the x-direction.

The distance D between a plane extending through the centre of the lens and a parallel plane extending along the second surface 310 of the alignment feature 304a can be precisely controlled because the replication section 258 for the lens and the replication section 259 for the alignment feature 304a are in the same master tool 260.

As shown in FIGS. 3a and 3b, the alignment feature 304a is located at a corner of the individual substrate. As a result of the dicing process a portion of the individual substrate 306 may extend in the x-direction beyond the second surface 310 of the alignment feature 304a. Similarly, as a result of the dicing process a portion of the individual substrate 306 may extend in the y-direction beyond the first surface 308 of the alignment feature 304a. That is, the alignment feature 304a (and the other alignment features 304b-c) may be set back from a corner of the individual substrate 306 in both the x and y directions.

As will be explained in more detail below, when the lens 302 is placed in a jig the first surface 308 of the alignment feature 304a rests against a surface of the jig and the second surface 310 of the alignment feature 304a rests against another surface of the jig to ensure that the lens is in a desired position with respect to the optical element.

When in the desired position the structure 300 is rotated about the y-axis such that one of the sides of the individual substrate is elevated at an angle a to the horizontal. This elevation angle seen from viewing direction V1 is shown in FIG. 3c. When in the desired position the structure 300 is rotated about the x-axis such that another of the sides of the individual substrate is elevated at an angle (pi to the horizontal. This elevation angle (φ seen from viewing direction V2 is shown in FIG. 3d. In embodiments of the present disclosure it is gravity which guides the lens 302 to be self-aligned with the optical element.

Whilst FIGS. 3a and 3b illustrates an example lens 302 formed on an individual substrate 306 having four alignment features 304 provided at each corner of the individual substrate 306, the shape and number of integrated alignment features 304 shown in FIGS. 3a and 3b is just an example and many other variants are possible. For example, in one variant the lens may have only a single alignment feature 304a at one corner of the individual substrate 306.

FIG. 3e illustrates another example lens 302 formed on an individual substrate 306 having a single integrated alignment feature 304 which fully encloses the lens. The alignment feature 304 shown in FIG. 3e has a first surface 308 extending in the x-direction for resting against a surface of the jig and a second surface 310 extending in the y-direction for resting against another surface of the jig to ensure that the lens is in a desired position with respect to the optical element.

FIG. 3f illustrates another example lens 302 formed on an individual substrate 306 having a single integrated alignment feature 304 which is formed of two portions. The alignment feature 304 shown in FIG. 3f has a first portion comprising a first surface 308 extending in the x-direction for resting against a surface of the jig and second portion comprising a second surface 310 extending in the y-direction for resting against another surface of the jig to ensure that the lens is in a desired position with respect to the optical element. In the example shown in FIG. 3f, the first portion of the alignment feature 304 is mechanically separate from the second portion of the alignment feature 304.

At step S108, an optical element is located in a jig 400. The optical element 402 may be a prism (e.g. a right-angled prism), a beam splitter, an assembly of optics, a diffraction grating, a fibre optic, an element with one or more apertures etc. The jig 400 is device which has a recess for holding the optical element in a predetermined orientation. The jig may have a single recess for holding only one optical element or may have a plurality of recesses such that the jig is arranged to hold a plurality of optical elements.

At step S110, the structure 300 is placed onto the optical element that is held in the jig 400. Before this placing, a suitable adhesive is applied to a surface of the optical element that will come into contact with the underside of the individual substrate 306 and/or the adhesive is applied to the underside of the individual substrate 306 that will come into contact with the optical element.

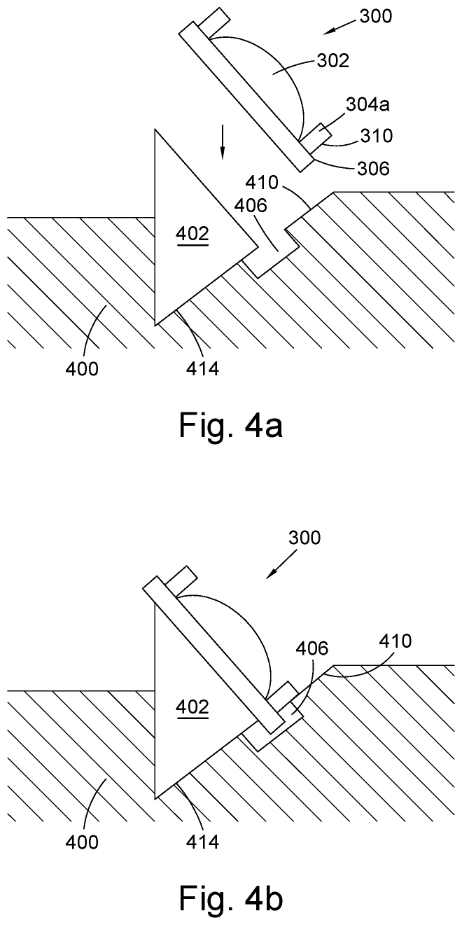

FIG. 4a illustrates an optical element 402 in the form of a right-angled prism that has been placed into the jig. This is just one example of an optical element that may be used in embodiments of the present disclosure.

FIG. 4b illustrates how the structure 300 is positioned on its counterpart, the optical element 402. The jig 400 holds the optical element in an orientation such that gravity guides the lens into a desired position relative to the optical element. In particular, when the lens is placed in the jig the first surface 308 of the integrated alignment feature extending in the x-direction rests against a first surface 408 of the jig, and the second surface 310 of the integrated alignment feature extending in the y-direction rests against a second surface 410 of the jig. It will be appreciated that FIG. 4b is a two-dimensional representation and can thus only show the latter.

The first surface 408 of the jig and the second surface 410 of the jig ensure precise lens positioning with respect to the optical element 402 in both the x-direction and the orthogonal y-direction.

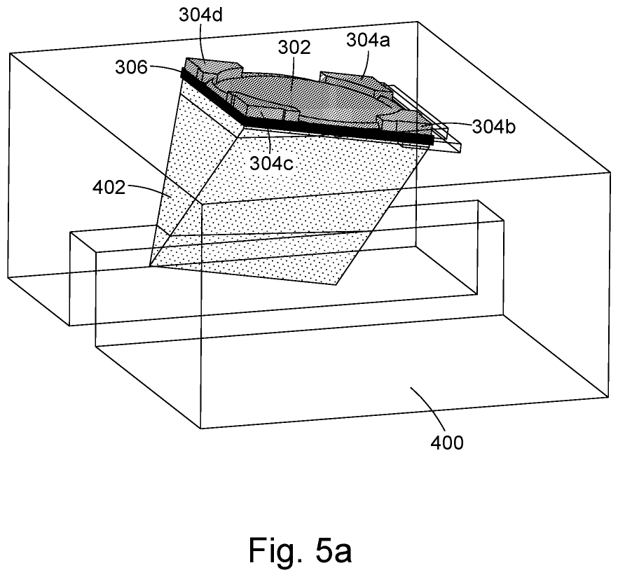

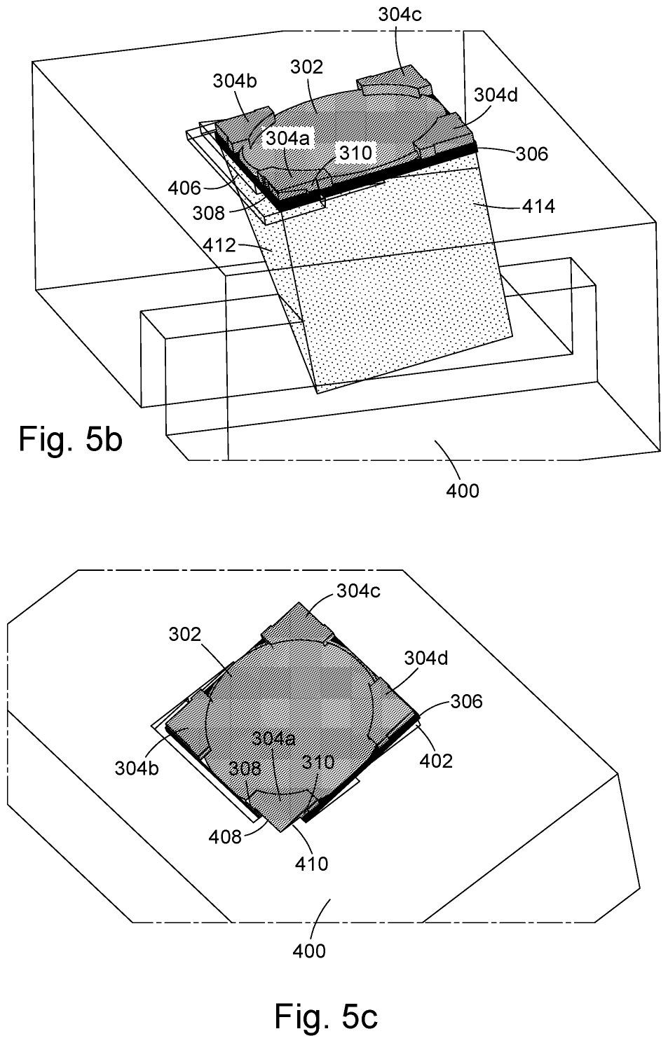

When in the desired position the first surface 308 of the integrated alignment feature 304a is in the same plane as a first surface 412 of the optical element 402 (this is shown in FIG. 5b), and the second surface 310 of the integrated alignment feature 304a is in the same plane as a second surface 414 of the optical element 402 (this is shown in FIGS. 4b and 5b).

In implementations whereby as a result of the dicing process a portion of the individual substrate 306 extends in the x-direction beyond the second surface 310 of the alignment feature 304a and a portion of the individual substrate 306 extends in the y-direction beyond the first surface 308 the alignment feature 304a, the jig 400 comprises a cavity 406 for receiving these portions of the individual substrate 306. It will be appreciated that FIG. 4b is a two-dimensional representation and thus only shows the cavity 406 receiving the portion of the individual substrate 306 which extends in the x-direction beyond the second surface 310 of the alignment feature 304a.

FIGS. 5a-c are three-dimensional representations showing the 302 lens positioned onto an optical element 402 that is placed in a jig 400. Whilst FIGS. 5a-c illustrate the optical element 402 in the form of a right-angled prism this is just one example of an optical element that can be used in embodiments of the present disclosure.

FIG. 5a illustrates that the jig 400 holds the optical element 402 in an orientation such that when the lens is placed in the jig gravity guides the lens 302 into a desired position relative to the optical element.

FIG. 5b illustrates that when the lens is in the desired position relative to the optical element the first surface 308 of the integrated alignment feature 304a is in the same plane as the first surface 412 of the optical element 402 (this is shown in FIG. 5b), and the second surface 310 of the integrated alignment feature 304a is in the same plane as the second surface 414 of the optical element 402.

FIG. 5c illustrates that when the lens is in the desired position relative to the optical element the first surface 308 of the integrated alignment feature 304a extending in the x-direction rests against a first surface 408 of the jig, and the second surface 310 of the integrated alignment feature 304a extending in the y-direction rests against a second surface 410 of the jig.

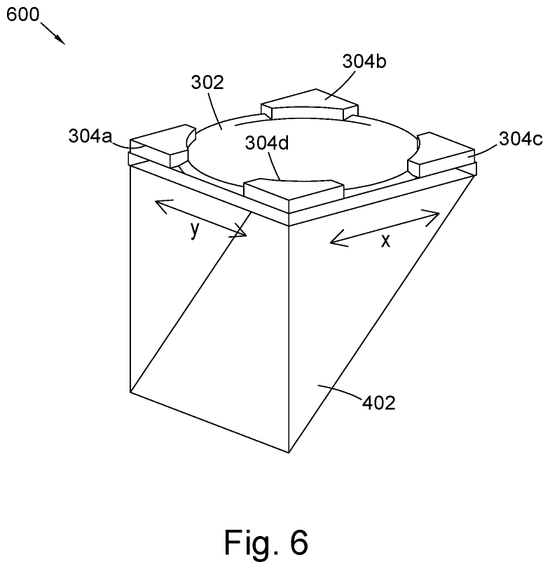

Once the adhesive has set the optical system 600 comprising the lens 302 fixed to the optical element 402 can be removed from the jig 400. FIG. 6 illustrates the optical system 600 made according to embodiments of the present disclosure. Such an optical system 600 has precise positioning of the lens 302 with respect to the optical element 402 with an achievable accuracy of less than +/−5 um in both the x-direction and y-direction.

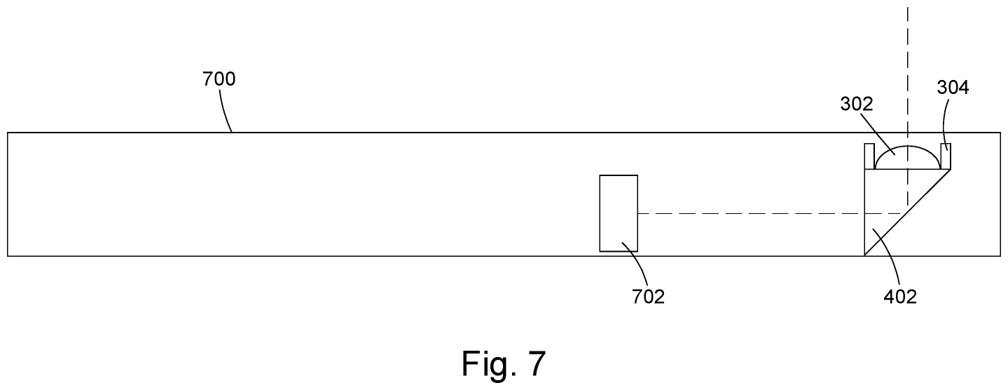

The optical system 600 can be incorporated into a computing device 700 as shown in FIG. 7. The computing device may a mobile phone, tablet, personal computer, gaming device, wearable device (e.g. smartwatch) or any other computing device.

FIG. 7 shows an example implementation where the optical element 402 is a right-angled prism incorporated into a mobile phone 700. The mobile phone 700 comprises an aperture for receiving light. The light is incident on the lens 302 adhered to the optical element 402 in accordance with embodiments of the present disclosure. The optical element 402 directs the incident light towards an image sensor 702 that is operable to capture an image of the environment of the mobile phone 700. It will be appreciated that one or more lenses (a mico-lens array) may be provided between the optical element 402 and the image sensor 702.

Although the disclosure has been described in terms of various embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### List of Reference Numerals

100 process
250 Dispensing tool
251 replication material
252 master tool forming substrate
253 hardened replication material
254 liquid photoresist
255 light
256 masking layer
258 replication section for a lens
259 replication section for an alignment feature
260 master tool
300 structure
302 lens
304 alignment feature
306 individual substrate
308 first surface of an alignment feature
310 second surface of an alignment feature
400 jig
402 optical element
406 cavity
408 first surface of a jig
410 second surface of a jig
412 first surface of an optical element
414 second surface of an optical element
600 optical system
700 computing device
702 image sensor

1. A method of forming an optical system comprising a lens and an optical element, wherein the method comprises:
forming a master tool using a lithographic apparatus;
forming a substrate, using the master tool, comprising a plurality of lenses and associated lens alignment features;
dicing the substrate to form individual substrates, each having a lens with an integrated lens alignment feature;
locating the optical element in a jig; and
placing a lens of the plurality of lenses in the jig such that the integrated alignment feature for said lens rests against surfaces of the jig thereby placing the lens in a desired position relative to the optical element.

2. The method of claim 1, wherein the lens is placed in the jig such that a first surface of the integrated alignment feature extending in a first direction rests against a first surface of the jig, and a second surface of the integrated alignment feature extending in a second direction orthogonal to the first direction rests against a second surface of the jig.

3. The method of claim 2, wherein in the desired position the first surface of the integrated alignment feature is in the same plane as a first surface of the optical element, and the second surface of the integrated alignment feature is in the same plane as a second surface of the optical element.

4. The method of claim 2, wherein the first surface of the integrated alignment feature and the second surface of the integrated alignment feature extend in a third direction that is parallel to an optical axis of the lens.

5. The method according to claim 1, wherein the jig comprises a cavity and once said lens is placed in the jig, portions of the individual substrate onto which said lens has been formed onto, extend into said cavity.

6. The method according to claim 1, wherein the optical element is located in said jig such that during said placing gravity guides the lens into the desired position.

7. The method according to claim 1, wherein the master tool is formed such that when the substrate is diced, the individual substrates each have a lens with a single integrated lens alignment feature.

8. The method according to claim 1, wherein the master tool is formed such that when the substrate is diced, the individual substrates each have a lens with a plurality of integrated lens alignment features.

9. The method according to claim 8, wherein the master tool is formed such that when the substrate is diced, the individual substrates each have a lens with an integrated lens alignment feature provided at each corner of the individual substrate.

10. The method of claim 1, wherein forming the master tool using the lithographic apparatus comprises:
depositing replication material onto a master tool forming substrate;
hardening the replication material to form hardened replication material shaped corresponding to said lenses;
dispensing liquid photoresist onto the master tool forming substrate;
exposing light to only selected portions of the liquid photoresist to form hardened photoresist shaped corresponding to the lens alignment features;
removing remaining unexposed liquid photoresist;
depositing a liquid material over the substrate, the hardened replication material, and the hardened photoresist; and
curing said liquid material to form the master tool.

11. The method of claim 10, wherein said exposing light to selected portions of the liquid photoresist comprises:
positioning a transparent masking structure over the master tool forming substrate, the transparent masking structure comprising a masking layer; and
emitting the light through said transparent masking structure.

12. The method of claim 1, wherein using the master tool to form the substrate comprising a plurality of lenses and associated lens alignment features comprises:
aligning the master tool and the substrate with respect to each other and bringing the master tool and a first side of the substrate together, with replication material between the master tool and the substrate;
hardening the replication material; and
separating the master tool from the substrate with the hardened replication material adhering to the substrate and forming the plurality of lenses and associated lens alignment features.

13. The method of claim 1, wherein the optical element is a prism.

14. The method of claim 1, wherein the optical element is a right-angled prism.

15. An optical system made according to the method of claim 1.

16. An optical system comprising a lens fixed to another optical element, wherein the lens is provided with an integrated alignment feature.

17. The optical system of claim 16, wherein the lens and the integrated alignment feature are formed using wafer level optics processing.
